(19) United States
(12) Patent Application Publication
(10) Pub. No.: US 2011/0157035 A1
(43) Pub. Date: Jun. 30, 2011

(54) ACTUATOR MODULE

(76) Inventors: Ki Suk WOO, Seoul (KR); Yeon Ho Son, Gyunggi-do (KR); Su Young Jung, Gyunggi-do (KR); Dong Sun Park, Seoul (KR); Dae Woong Yun, Incheon (KR); Kum Kyung Lee, Gyunggi-do (KR); Ji Yeoun Jang, Gyunggi-do (KR); Jae Kyung Kim, Gyunggi-do (KR)

(21) Appl. No.: 12/773,676

(22) Filed: May 4, 2010

(30) Foreign Application Priority Data
Dec. 31, 2009 (KR) 10-2009-0136064

(51) Int. Cl. G06F 3/041

(52) U.S. Cl. 345/173

(57) ABSTRACT

Disclosed herein is an actuator module that improves vibration of a touch screen pad. More specifically, the actuator module is configured to include a plate that is positioned at the lower part of a touch display module in which an image display unit is coupled to the lower part of a touch screen panel, a vibration generator that is positioned at the lower part of the plate and is mechanically deformed by compression or contraction when voltage is applied, and an adhesive layer that bonds the touch display module to the plate and the plate to the vibration generator and generates bending moment by the mechanical deformation of the vibration generator, thereby making it possible to transfer the vibration by the vibration generator directly to the touch screen panel and be designed in an ultra-thin type.

### CROSS REFERENCE TO RELATED APPLICATION

This application claims the benefit of Korean Patent Application No. 10-2009-0136064, filed on Dec. 31, 2009, entitled “Actuator Module”, which is hereby incorporated by reference in its entirety into this application.

### BACKGROUND OF THE INVENTION

1. Technical Field

The present invention relates to an actuator module that can improve vibration of a touch screen pad and be designed in an ultra-thin type.

2. Description of the Related Art

Recently, touch screen apparatuses are generally mounted on various electronic products so that users can conveniently use them. The touch screen apparatus is to reflect a user's intuitive experience to an interface and more diversify feedbacks, in addition to the input of information.

The touch screen apparatus as described above has the following advantages: it can reduce space for interface, a user can easily operate the touch screen apparatus, a user can easily access information, a user can easily change its specification, it can easily interwork with IT equipments, and it can have a user's high recognition, product differentiation, etc. Therefore, the touch screen apparatus has been widely used in various fields, such as industry, traffic, service, medicine, mobile, etc.

Generally, a touch screen apparatus of the related art is formed in such a manner that if a user presses a touch screen panel, while seeing an image displayed through the touch screen panel, vibration by a vibration generator is transferred to the touch screen panel so that the user can feel the vibration.

Such vibration may be referred to as tactile implementation of the touch screen apparatus. With the constitution of the touch screen with the tactile implementation function of the related art, a touch display module in which an image display unit that displays an image such as LCD, etc. is attached to the lower part of a transparent touch screen panel is coupled to an equipment set, and a vibration generator for the tactile implementation is mounted on a portion of the equipment set.

However, in the touch screen apparatus with such a constitution, the touch screen is disadvantageous in that the vibration by the vibration generator is fully transferred to the equipment set but is not fully transferred to the touch display module. In other words, for example, when a user operates a cellular phone by pressing the touch screen panel on the cellular phone with fingers, the user fully feels the vibration transferred to his or her hand gripping the cellular phone but he or she hardly feels the vibration on the touch screen panel pressed with fingers.

Meanwhile, in order to maximize the vibration on the touch screen panel, the vibration generator is directly attached to the lower part of the touch display module so that the vibration generated from the touch display module should be directly transferred to the touch screen panel. However, in this case, if the vibration generator is directly attached to the touch display module, it is difficult for the actuator module to be designed in a thin type.

### SUMMARY OF THE INVENTION

The present invention has been made in an effort to provide an actuator module that fully transfers vibration to a touch screen panel by attaching a vibration generator directly to a touch display module.

Another object of the present invention is to provide an actuator module that can be designed in an ultra-thin type through a structure where a vibration generator is directly bonded to a plate attached to a touch display module.

Still another object of the present invention is to provide an actuator module that can control vibration of a vibration generator in order to improve vibration transferred to a touch screen panel.

An actuator module according to the present invention includes: a plate that is positioned at the lower part of a touch display module in which an image display unit is coupled to the lower part of a touch screen panel; a vibration generator that is positioned at the lower part of the plate and is mechanically deformed by compression or contraction when voltage is applied; a first adhesive layer that bonds the touch display module to the plate; and a second adhesive layer that bonds the plate to the vibration generator, wherein the first adhesive layer and the second adhesive layer generate bending moment by the mechanical deformation of the vibration generator.

The thickness of the adhesive layer may become thick in order to increase the moment.

The adhesive layer may be a double-sided adhesive tape form, wherein the adhesive layer in the double-sided adhesive tape is repeatedly bonded twice or more.

A compensating layer may be formed between the adhesive layers in order to increase the moment.

The compensating layer may be made of polycarbonate or polymer material and the length of the compensating layer may be formed to be longer than that of the vibration generator.

### BRIEF DESCRIPTION OF THE DRAWINGS

FIG. 1 is a perspective view illustrating an actuator module according to a first embodiment of the present invention;

FIG. 2 is a cross-sectional view taken along lines A-A of FIG. 1;

FIG. 3 is a cross-sectional view explaining mechanical deformation of a vibration generator of FIG. 2;

FIG. 4 is a cross-sectional view explaining a mechanical deformation status of FIG. 3;

FIG. 5 is a graph illustrating driving variation of a touch screen panel according to thickness of an adhesive layer according to the present invention;

FIG. 6 is a cross-sectional view illustrating an actuator module according to a second embodiment of the present invention;

FIG. 7 is a cross-sectional view illustrating an actuator module according to a third embodiment of the present invention;

FIG. 8 is a cross-sectional view illustrating an actuator module according to a fourth embodiment of the present invention; and

FIG. 9 is a cross-sectional view illustrating an actuator module according to a fifth embodiment of the present invention.

### DESCRIPTION OF THE PREFERRED EMBODIMENTS

Various features and advantages of the present invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. Herein, the same reference numerals are used throughout the different drawings to designate the same components. Further, when it is determined that the detailed description of the known art related to the present invention might obscure the gist of the present invention, the detailed description thereof will be omitted.

Hereinafter, the preferred embodiments of the present invention will be described in detail with reference to the accompanying drawings.

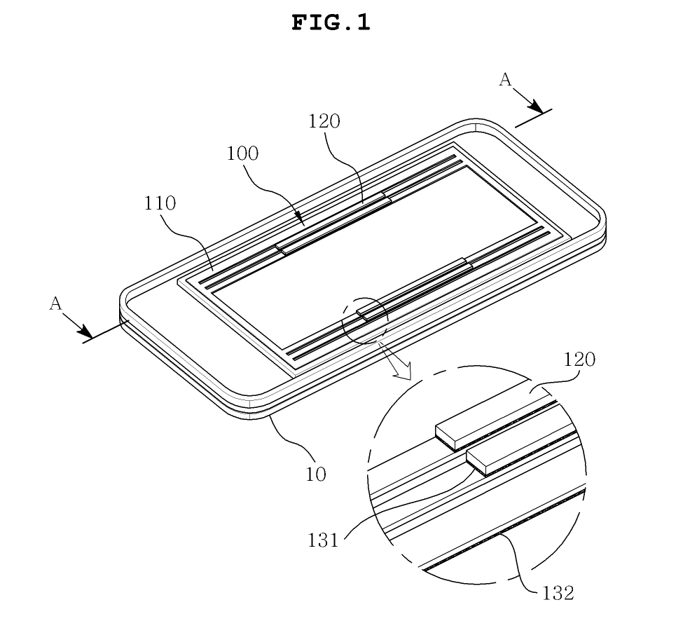

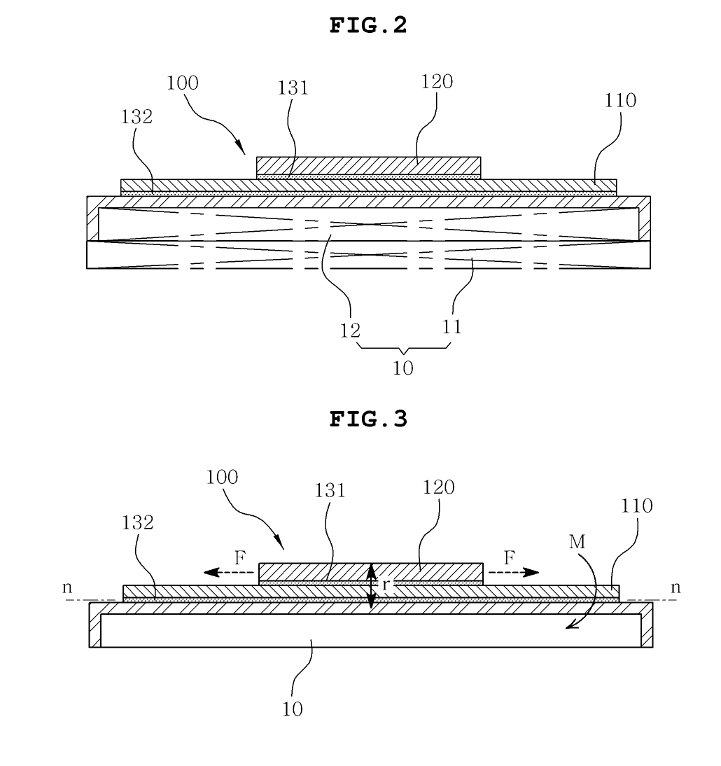

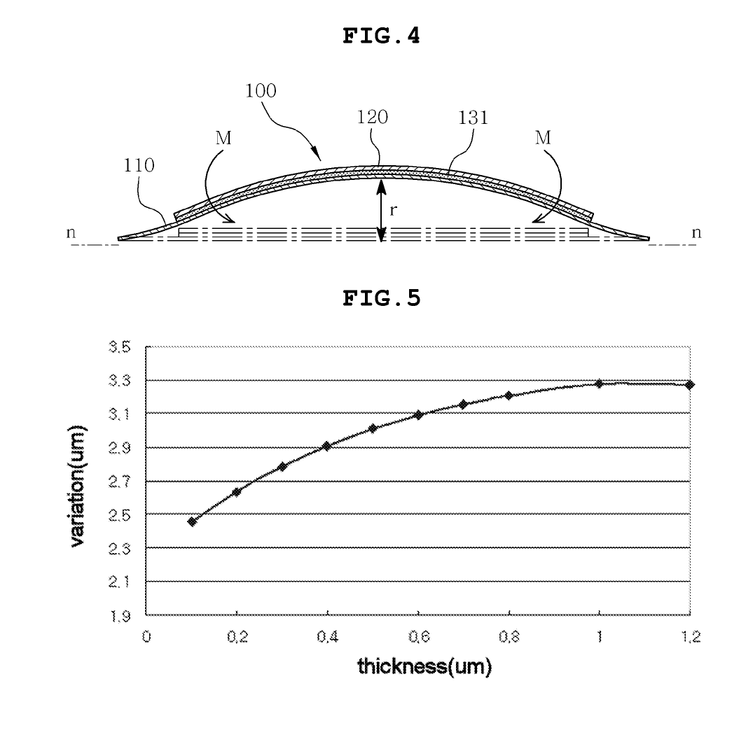

FIG. 1 is a perspective view illustrating an actuator module according to a first embodiment of the present invention, FIG. 2 is a cross-sectional view taken along lines A-A of FIG. 1, FIG. 3 is a cross-sectional view explaining mechanical deformation of a vibration generator in FIG. 2, and FIG. 4 is a cross-sectional view explaining a mechanical deformation status of FIG. 3.

As shown in FIGS. 1 to 4, an actuator module 100 according to the present invention includes plates 110, a vibration generator 120, and an adhesive layer 130.

A touch display module 10 using the actuator module of the present invention has a structure where an image display unit 12 such as LCD is coupled to the lower part of a touch screen panel 11 as shown in FIG. 2. The touch display module 10 is a unit that inputs user's requests by pressing the touch screen panel 11 while seeing an image displayed on the image display unit 12.

The touch screen panel 11 has transparency and flexibility in order to input signals by pressing the surface thereof, while seeing the image displayed on the image display unit. The touch screen panel may be formed by stacking an external film layer, an ITO film layer, and a base film layer, which is provided by way of example. In this case, the external film layer may, for example, be divided into a viewing area that is mounted on the front part of a mobile communication terminal and input by the touch and a dead space area that is formed around the viewing area. The external film layer is made of transparent film material, for example, poly ethylene terephtalate (PET), in order that the screen of the image display unit can be displayed. Further, the indium tin oxide (ITO) film layer is formed by stacking upper and lower film layers, wherein a dot space that constantly maintains the interval thereof is provided therebetween. The upper and lower film layers are provided with a membrane electrode in which a conductive X-axis pattern and a conductive Y-axis pattern are formed along the edges thereof, wherein the X-axis pattern and the Y-axis pattern are electrically isolated by an insulator. The membrane electrode is exposed to the outside of the ITO film layer through a FPC cable to be connected electrically to a portable terminal. Further, a base film layer, which serves to support the entire touch screen panel 11, uses, for example, a glass substrate having high transmittance and excellent response speed.

The plate 110, which is positioned at the lower part of the touch display module 10, provides a surface to which the vibration generator 120 is bonded and at the same time, transfers the vibration generated from the vibration generator 120 to the touch display module 10. As shown in FIGS. 3 and 4, the plate 110 is made of flexible material that is deformable corresponding to the mechanical deformation by contraction and expansion of the vibration generator 120 and the bending moment by adhesive layers 131 and 132.

As shown in FIG. 1, for example, the plate 110 is formed in a pair or more, which are positioned in parallel at the lower part of the touch display module in a longitudinal direction or in a traverse direction 10. At this time, the plates 110 in a pair or more may be configured to include a frame connecting both ends of the plates and positioned along the boundary of the touch display module 10. In this case, the frame may maintain the interval between the plates 110 positioned in parallel and improve adhesive force by a second adhesive layer 132. Meanwhile, the plates 110 are bonded to the touch display module 10 by the second adhesive layer 132.

The vibration generator 120, which is positioned at the lower part of the plate 110, is mechanically deformed by compression or contraction when external voltage is applied. The vibration generator 120 may, for example, be a general piezoelectric actuator or polymer actuator. The vibration generator 120 may be formed in a pair or more together with the plates 110, as shown in FIG. 1.

The adhesive layers 131 and 132 are bonded to each other by the second adhesive layer 132 between the touch display module 10 and the plate 110 and the first adhesive layer 131 between the plate 110 and the vibration generator 120, thereby generating a bending moment by the mechanical deformation of the vibration generator 120. As shown in FIGS. 2 to 5, the adhesive layers 131 and 132 may be formed by coating or printing and may be a double-sided adhesive tape form as shown in FIG. 7.

With the constitution as described above, when voltage is applied to the vibration generator 120 of the actuator module 100, the vibration generator 120 is contracted and expanded as shown in FIG. 3, thereby generating driving force (F) during the contraction and the expansion of the vibration generator 120. At this time, the plate 110 and the vibration generator 120 are bonded by the first adhesive layer 131, thereby being operated as a bending moment that is bent as shown in FIG. 4. When the voltage applied to the vibration generator 120 is stopped, the plate 110 and the vibration generator 120 are restored to their original shapes. The operation as described above is rapidly repeated, thereby generating vibration. It is to be understood that FIG. 4 explains the shape where the actuator module is bent.

At this time, the moment is in proportion to the driving force (F) and is in proportion to the moment arm generated during the bending, that is, a distance r being apart from an interface n-n of the touch display module 10. In formula, M (moment)=F (driving force) X r (moment arm). Therefore, when the moment arm increases, the moment increases and when the moment increases, the vibration improves.

FIG. 5 is a graph illustrating driving variation of the touch screen panel according to the thickness of the adhesive layer according to the present invention.

As shown in FIG. 5, when the thickness of the adhesive layers 131 and 132 increases, the increase of the moment arm (r) is greater than the increase of stiffness, thereby increasing the driving variation of the touch screen panel 11 within the predetermined range, that is, the vibration. The stiffness of the adhesive layers 131 and 132 has relatively very small value than the plate or the touch display module 10, such that the increase of the moment arm (r) has an effect on the entire bending moment.

In addition, as shown in the graph of FIG. 5, the thickness of the adhesive layers 131 and 132 is preferably formed in the range not exceeding 1 mm, in view of the general range thereof or the management of the thickness of the adhesive layers 131 and 132. When exceeding such a range, the entire bending moment cannot be increased in proportion to the change in the thickness of the adhesive layers 131 and 132.

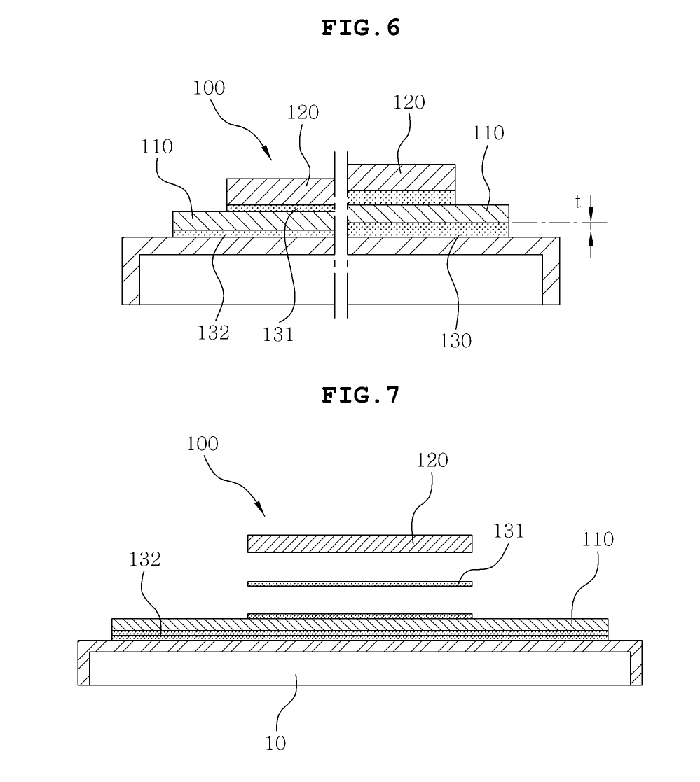

FIG. 6 is a cross-sectional view illustrating an actuator module according to a second embodiment of the present invention, and FIG. 7 is a cross-sectional view illustrating an actuator module according to a third embodiment of the present invention.

According to the second embodiment of the present invention, the thickness of the adhesive layers 131 and 132 should be formed to be thick in order to increase the moment and improve the vibration transferred to the touch screen panel 11. In other words, as shown in FIG. 6, the second adhesive layer 132 is formed to be thick by a predetermined thickness “t”, such that the moment increases in proportion to the thickness “t”. At this time, when the second adhesive layer 132 is formed by coating or printing, the second adhesive layer 132 may be formed to be thick by controlling a coating apparatus or a printing apparatus. It is obvious that the same manner can be also applied to the first adhesive layer 131.

According to the third embodiment of the present invention, the adhesive layers 131 and 132 may be a double-sided adhesive tape form. In this case, as shown in FIG. 7, the adhesive layers 131 and 132 in a tape form are repeatedly bonded twice or more in order to increase the moment and improve the vibration transferred to the touch screen panel 11.

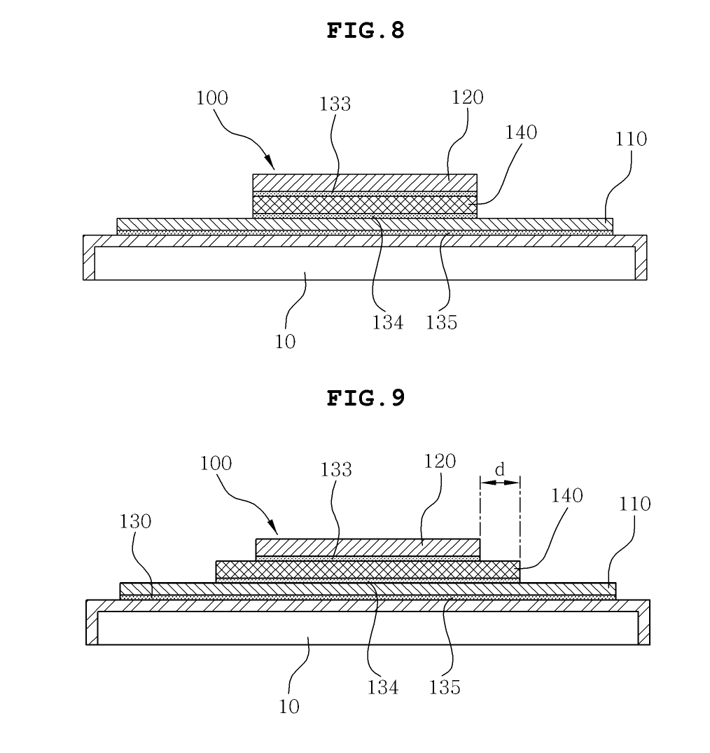

FIG. 8 is a cross-sectional view illustrating an actuator module according to a fourth embodiment of the present invention.

According to the fourth embodiment of the present invention, as shown in FIG. 8, a compensating layer 140 is formed between a first adhesive layer 133 and a second adhesive layer 134 as the unit that increases the moment and improves the vibration transferred to the touch screen panel 11. Further, a third adhesive layer 135 between plates may be formed, together with the compensating layer 140. The compensating layer 140 between the adhesive layers 133 and 134 serves the same function as that the thickness of the adhesive layers 133 and 134 increases. Such a compensating layer 130 is made of flexible polycarbonate or polymer material.

The compensating layer 140 is easily formed in a desired thickness, thereby more conveniently control the vibration than the case where the touch screen panel is formed of only the adhesive layer 130.

Meanwhile, although it is shown that the compensating layer 140 is formed between the first adhesive layer 133 and the second adhesive layer 134, the first adhesive layer 133 and the second adhesive layer 134 being formed between the plate 110 and the vibration generator 120, this is provided by way of example only. Therefore, the compensating layer 140 may also be formed between the second adhesive layer 134 and the third adhesive layer 135, the second adhesive layer 134 and the third adhesive layer 135 being formed between the touch display module 10 and the plate 110. Further, the thickness of the first adhesive layer, the second adhesive layer or the third adhesive layer may be formed to be thinner than that of the plate. As described above, when the thickness of the adhesive layer exceeds a predetermined thickness, the bending moment is not increased as shown in the graph of FIG. 5. Therefore, the thickness of the adhesive layer is generally formed to be thinner than that of the plate.

FIG. 9 is a cross-sectional view illustrating an actuator module according to a fifth embodiment of the present invention.

According to the fifth embodiment of the present invention, the compensating layer 140 may be formed to be longer than the vibration generator 120. In other words, as shown in FIG. 9, the both ends of the compensating layer 140 may be bonded to each other in a state where they are more projected by a predetermined distance “d” than both ends of the vibration generator 120.

According to the constitution and the effects of the present invention, the vibration generator 120 is attached to the lower part of the touch display module 10 through the plate 110, such that the vibration by the vibration generator 120 is fully transferred to the touch screen panel 11. Further, the actuator module can be designed in a thin type according to the constitution as described above.

Further, the vibration of the vibration generator 120 is increased or controlled by controlling the thickness of the adhesive layer 130 or the compensating layer 140, thereby making it possible to more easily control the vibration transferred to the touch screen panel 11.

According to the actuator module of the present invention, the vibration generator is bonded to the lower part of the touch display module through the plate, thereby making it possible to fully transfer the vibration by the vibration generator to the touch screen panel.

According to the actuator module of the present invention, the vibration generator is bonded directly to the lower part of the plate, thereby making it possible to design the actuator module in an ultra-thin type for vibrating the touch screen panel.

According to the actuator module of the present invention, the vibration of the vibration generator is increased or properly controlled by controlling the thickness of the adhesive layer or the compensating layer, thereby making it possible to control the vibration transferred to the touch screen panel.

Although the preferred embodiments of the present invention have been disclosed for illustrative purposes, they are for specifically explaining the present invention and thus the actuator module according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. An actuator module comprising:
a plate that is positioned at the lower part of a touch display module in which an image display unit is coupled to the lower part of a touch screen panel;
a vibration generator that is positioned at the lower part of the plate and is mechanically deformed by compression or contraction when voltage is applied;
a first adhesive layer that bonds the touch display module to the plate; and
a second adhesive layer that bonds the plate to the vibration generator,
wherein the first adhesive layer and the second adhesive layer generate bending moment by the mechanical deformation of the vibration generator.

2. The actuator module as set forth in claim 1, wherein the thickness of the first adhesive layer or the second adhesive layer is thinner than that of the plate.

3. The actuator module as set forth in claim 1, wherein the first adhesive layer or the second adhesive layer is a double-sided adhesive tape form.

4. The actuator module as set forth in claim 3, wherein the first adhesive layer or the second adhesive layer in the tape form is repeatedly bonded twice or more.

5. The actuator module as set forth in claim 1, wherein a compensating layer is formed between the adhesive layers in order to increase the moment.

6. An actuator module comprising:
a first adhesive layer that is formed between a touch display module and a plate;
a second adhesive layer that is formed between the plate and a compensating layer; and
a third adhesive layer that is formed between the compensating layer and a vibration generator,
wherein the first adhesive layer, the second adhesive layer, and the third adhesive layer generate bending moment by the mechanical deformation of the vibration generator.

7. The actuator module as set forth in claim 6, wherein the thickness of the first adhesive layer, the second adhesive layer or the third adhesive layer is thinner than that of the plate.

8. The actuator module as set forth in claim 5, wherein the compensating layer is made of polycarbonate or polymer material.

9. The actuator module as set forth in claim 6, wherein the length of the compensating layer is formed to be longer than that of the vibration generator.

10. The actuator module as set forth in claim 1, wherein as the thickness of the first adhesive layer or the second adhesive layer increases, the bending moment by the mechanical deformation of the vibration generator increases.
